(19) United States
(12) Patent Application Publication
(10) Pub. No.: US 2007/0133689 A1
(43) Pub. Date: Jun. 14, 2007

(54) Low-cost motion estimation apparatus and method thereof

(76) Inventors: Seong Mo Park, Yuseong-gu (KR); Han Jin Cho, Wolpyung-dong (KR); Hee Bum Jung, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/545,296

(22) Filed: Oct. 10, 2006

(30) Foreign Application Priority Data
Dec. 8, 2005 (KR) 10-2005-0119475
Jul. 13, 2006 (KR) 10-2006-0065770

(51) Int. Cl. H04N 11/02; H04N 11/04

(52) U.S. Cl. 375/240.21; 375/240.24

(57) ABSTRACT

Provided are motion estimation algorithm development and design of a structure for implementing hardware of a motion estimator. A hardware structure that simultaneously satisfies MPEG-4 and H.264 standards and requires less hardware is provided. The provided structure is applicable to both MPEG-4 and H.264 using one hardware device according to the mode (MPEG-4 or H.264). The motion estimation apparatus includes: a sampling portion for sampling image data in units of blocks and generating sampling blocks; a block division/address generator for dividing the sampling blocks into sampling sub-blocks and generating addresses for motion estimation calculation; and a motion calculator for calculating motion using a motion estimation function for each sub-block.

### CROSS-REFERENCE TO RELATED APPLICATION

This application claims priority to and the benefit of Korean Patent Application Nos. 2005-119475, filed Dec. 8, 2005, and 2006-65770, filed Jul. 13, 2006, the disclosures of which are incorporated herein by reference in their entirety

### BACKGROUND

1. Field of the Invention

The present invention relates to the field of Very Large Scale Integration (VLSI) design for expressing image data with hardware using compression algorithms, and more particularly, to a motion estimation apparatus and a method thereof applicable to VLSI implementing image compression algorithms.

2. Discussion of Related Art

H.264 is a standard jointly developed by the Video Coding Experts Group (VCEG) of the International Telecommunications Union (ITU) and the Moving Picture Experts Group (MPEG) of the International Standard Organization (ISO), which establish international standards for moving pictures. H.264 is aimed at achieving a very high compression ratio and is a general-purpose moving picture coding technique that can be used in most transmission media such as recording media, the Internet, satellite broadcasting, etc., and in various moving picture resolution environments. Traditionally, ITU has established moving picture standards such as H.261, H.263, etc., on the basis of wired communication media, and MPEG has standardized MPEG-1, MPEG-2, etc. for processing moving pictures in recording media and broadcasting media. Also, MPEG has standardized an MPEG-4 moving picture standard that is a coding standard used in all types of multimedia, and implements various functions characterized by an object-based moving picture code and a high compression ratio. After the establishment of the MPEG-4 moving picture standard, VCEG of ITU went on to establish a moving picture standard known as H.26L with high compression performance. In MPEG's official comparison test, H.26L, having the same function as MPEG-4 (advanced simple profile), exhibited a superior compression ratio to MPEG-4. As a result of the test, MPEG and VCEG of ITU joined to form the Joint Video Team (JVT) and developed H.264/Advanced Video Coding (AVC), a moving picture standard based on H.26L.

Among a variety of excellent properties of H.264/AVC, a method of deciding an optimal coding mode improves its performance. An optimal coding mode decision module is a portion that decides a coding mode of a macroblock, a basic coding unit, in which motion estimation is essential.

Motion estimation is characterized in that the macroblock is divided into sub-blocks of various shapes, and each of the sub-blocks may have a motion vector. Also, in contrast to the conventional motion estimation method that uses a sheet of a reference image, a plurality of reference images are used in H.264/AVC, which enables considerable compression efficiency to be achieved.

However, these characteristics result in increased calculation. Therefore, motion estimation algorithms in H.264/AVC should be designed taking into account predictive errors and amount of calculation.

In conventional art such as that illustrated in FIG. 10, when Very-Large-Scale Integration (VLSI) is implemented using a motion estimation algorithm, additional memory is required, which increases physical area and power consumption.

Motion estimation requires a large amount of calculation, and thus extensive work on algorithms and hardware structures has been done. Combined motion estimation that uses a motion estimation skipping algorithm without diminishing image quality is provided in the conventional art. In addition, a motion vector prediction value is obtained by performing a process of motion vector prediction that selects a median value between a motion vector of a previous macroblock and motion vectors of top and top-right macroblocks of the current block before motion estimation is normally performed.

Next, a Sum of Absolute Difference Motion Compensation Prediction (SADmcp) value is obtained by performing motion compensation using the obtained prediction vector. Simultaneously, a maximum SAD value SADmax is obtained from input SAD values obtained from the previous macroblock and the top and top-right macroblocks. And, when the SADmcp value is less than SADmax, motion estimation may be skipped.

Since the above method is based on the MPEG-4 standard and motion is estimated in units of 16×16 macroblocks, image quality is diminished compared to a sub-block division method, and a motion estimation skip mode consumes a large amount of electricity due to additional circuits.

Since enormous amounts of calculation are required in the conventional art, real-time encoding in a moving picture encoder is difficult. Also, since the encoder requires additional memory, physical area and electric power consumption increase. In addition, since a static algorithm is used according to type of image and field of application, unnecessary calculations are performed, and there is a limit of having to use the proper motion estimation algorithm according to the type of image.

### SUMMARY OF THE INVENTION

The present invention is directed to a motion estimation apparatus and a method thereof for reducing hardware cost.

The present invention is also directed to a motion estimation apparatus and a method thereof for reducing calculations.

One aspect of the present invention provides a motion estimation apparatus including: a sampling portion for sampling image data in units of blocks and generating sampling blocks; a block division/address generator for dividing the sampling blocks into sampling sub-blocks and generating addresses for motion estimation calculation; and a motion calculator for calculating motion using a motion estimation function for each sub-block.

Another aspect of the present invention provides a motion estimation method including the steps of: sampling image data in units of predetermined blocks to thereby generate sampling blocks; dividing each of the sampling blocks into a plurality of sampling sub-blocks; calculating similarities between a region designated by each motion vector with respect to an external specific reference block and each of the sampling sub-blocks; and summing up the similarities of the motion vectors with respect to the plurality of sampling sub-blocks to thereby decide a motion vector with respect to the input image data.

Since the sub-blocks are divided into various shapes and encoded in H.264 standard, excellent performance and compression efficiency are achieved. However, these characteristics result in increased calculation. Therefore, the present invention provides a motion estimation algorithm and an optimal sub-block division method for minimizing hardware complexity as well as image quality deterioration.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of an exemplary general image compression device structure;

FIG. 2 is a block diagram of a motion estimation apparatus according to an exemplary embodiment of the present invention;

FIG. 3 is a conceptual diagram illustrating a 2:1 sampling process according to an exemplary embodiment of the present invention;

FIG. 4 is a memory map illustrating a search region forming reference blocks according to an exemplary embodiment of the present invention;

FIG. 5 is a block diagram illustrating block grouping in H.264 format according to an exemplary embodiment of the present invention;

FIG. 6 is a flowchart illustrating a motion estimation method according to an exemplary embodiment of the present invention;

FIG. 7 is a flowchart illustrating a motion calculation method in MPEG-4 format according to an exemplary embodiment of the present invention;

FIG. 8 is a flowchart illustrating a motion calculation method in H.264 format according to an exemplary embodiment of the present invention;

FIGS. 9A and 9B are circuit diagrams of a processing structure embedded in a motion estimation apparatus according to an exemplary embodiment of the present invention; and

FIG. 10 is a block diagram of a conventional motion estimation apparatus.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

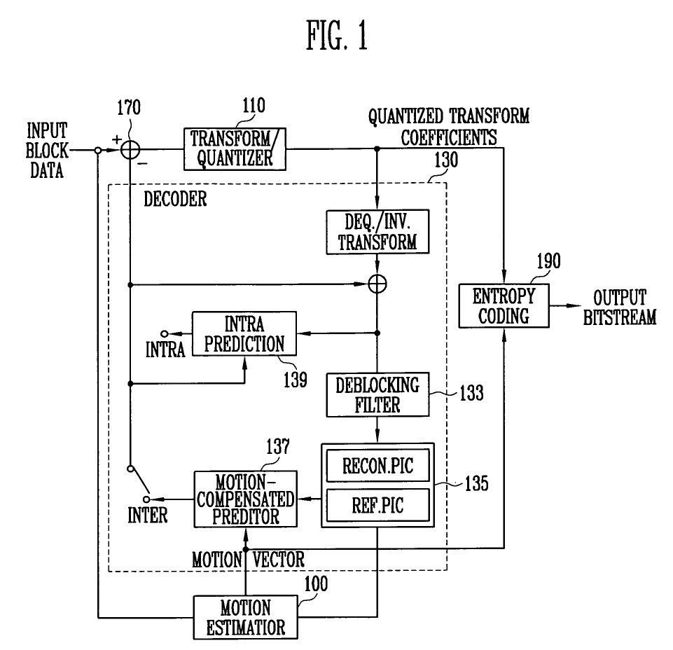

FIG. 1 is a block diagram of a general moving picture coding apparatus. Referring to FIG. 1, the moving picture coding apparatus includes a transform/quantizer 110, a dequantizer/inverse transform 131, a deblocking filter 133, a picture reproducer 135, a motion compensation predictor 137, an intra predictor 139, a motion estimator 100, a substractor 170, and an entropy coding portion 190.

Image data in units of macroblocks that consist of 16×16 pixels is input to the moving picture coding apparatus. The transform/quantizer 110 converts the input macroblocks and quantizes the converted macroblocks according to a predetermined method. Discrete Cosine Transform (DCT) is a representative image conversion method.

After conversion of the image data by the transform/quantizer 110, the dequantizer/inverse transform 131 receives quantized image data and performs inverse quantization and inverse conversion on the received image data. The deblocking filter 133 receives the inverse-quantized and inverse-converted image data from the dequantizer/Inverse transform 131, and performs filtering on the image data to remove a blocking effect.

The picture reproducer 135 receives the filtered image data from the deblocking filter 133 and reproduces and stores the image in units of pictures. A picture is an image in units of frames or fields. The picture reproducer 135 includes a buffer (not shown) capable of storing a plurality of the pictures. The plurality of pictures stored in the buffer are pictures provided for motion estimation, and hereinafter, each of the pictures will be referred to as a reference picture.

The motion estimator 100 is provided with at least one of the reference pictures stored in the picture reproducer 135, performs motion estimation on an input macroblock according to the present invention, and outputs motion data including an index and a block mode that denote motion vectors, and reference pictures.

The motion compensation predictor 137 extracts a macroblock corresponding to the input macroblock from a reference picture used for motion estimation among the plurality of reference pictures stored in the picture reproducer 135 according to the motion data input from the motion estimator 100, and outputs the result.

In the case of predictive coding of the input macroblock between the pictures, the substractor 170 receives a macroblock in a reference picture corresponding to the input macroblock from the motion compensation predictor 137, performs a difference operation on the input macroblock, and outputs a residue signal.

The residue signal output from the substractor 170 is converted and quantized by the transform/quantizer 110, and entropy-coded by the entropy coding portion 190 to thereby generate an output bitstream. The intra predictor 139 performs inter-picture predictive coding using a reference picture rather than predictive coding between the pictures.

Meanwhile, a moving picture decoder 130 for decoding the bitstream generated by the moving picture coding apparatus includes the dequantizer/inverse transform 131, the deblocking filter 133, the picture reproducer 135, the motion compensation predictor 137, and the intra predictor 139.

The present invention is directed to providing an improved technique with respect to a motion estimator 100 of FIG. 1. Therefore, the present invention may be applied to other moving picture coding devices that require a motion estimation apparatus having a different structure, in addition to the moving picture coding apparatus of FIG. 1.

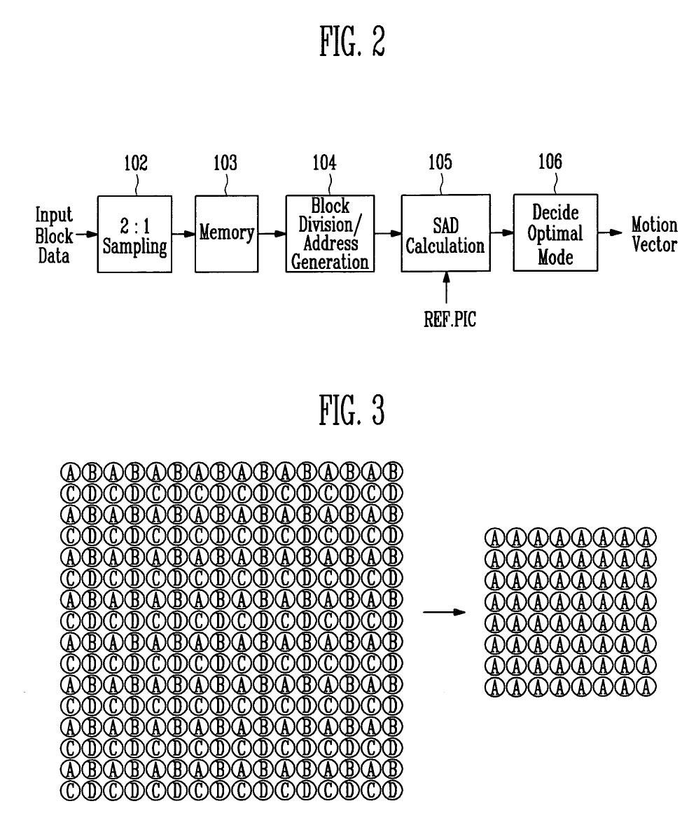

As illustrated in FIG. 2, the motion estimation apparatus according to an exemplary embodiment of the present invention includes a sampling portion 102 for sampling the image data in units of blocks and generating sampling blocks, a sampling memory 103 for storing the sampling blocks, a block division/address generator 104 for dividing the sampling blocks into sampling sub-blocks and generating addresses for motion estimation calculation, a motion calculator 105 for calculating motion for each of the sub-blocks using an estimation function; and an optimal mode decision portion 106 for deciding an optimal block grouping mode for moving picture compression.

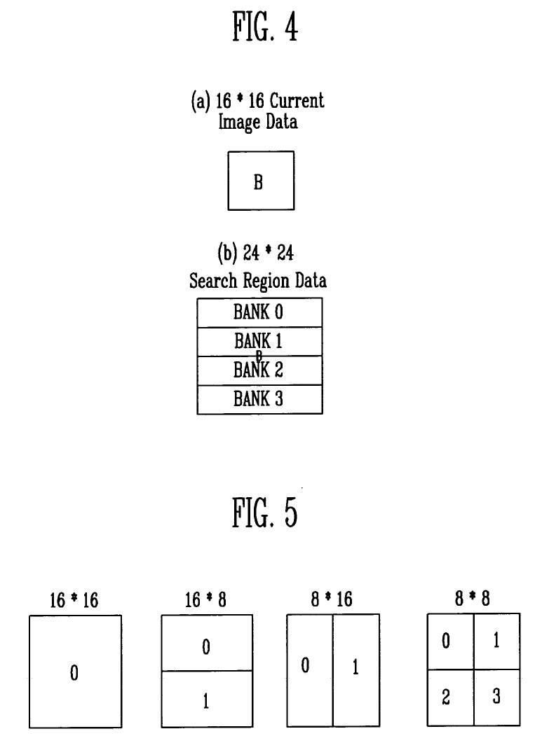

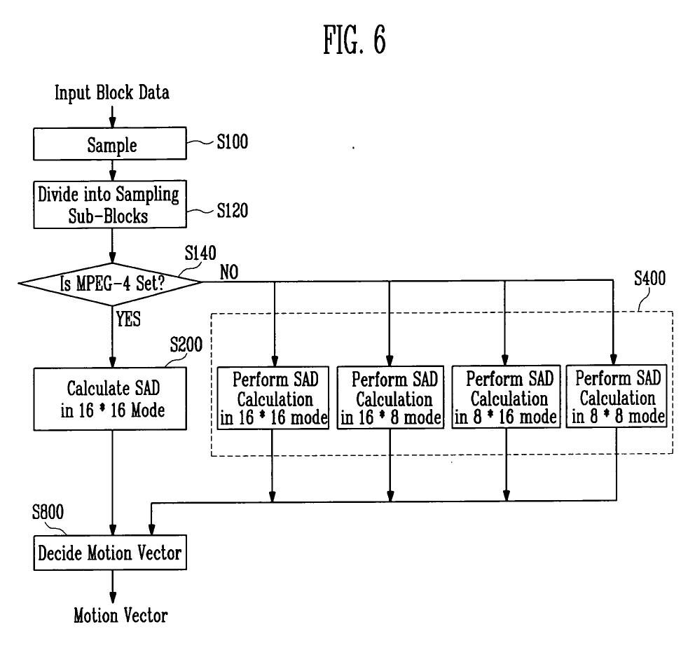

8×8 sampling blocks are generated by performing a 2:1 sampling process on 16×16 image data along both horizontal and vertical axes in the sampling portion 102. In other words, as illustrated in FIG. 3, the sampling portion 102 performs the 2:1 sampling process on the original image to thereby reduce calculation complexity in various block modes by reduction to one-quarter of the original data and stores the reduced data in the sampling memory 103. Accordingly, the size of the sampling memory 103 is reduced to one-quarter of the conventional memory for storing input blocks of a motion estimation apparatus.

The block division/address generator 104 divides an 8×8 sampling block into four 4×4 sampling sub-blocks. At this time, since each pixel of the 4×4 sampling sub-blocks is sampled at the ratio of 2:1, it corresponds to data in an 8×8 mode of the original image data. Also, the block division/address generator 104 designates a pixel leading location in a reference block given as a motion vector according to a compression mode.

The motion calculator 105 performs a Sum of Absolute Difference Motion Compensation Prediction (SADmcp) calculation on 4×4 sampling sub-blocks and the reference blocks divided from the block division/address generator 104. Instead of the SAD calculation, a Sum of Squared Difference (SSD) calculation may be performed.

The optimal mode decision portion 106 is used for selecting one of four block grouping modes that the H.264 standard defines, and may be omitted in an apparatus that does not support the H.264 standard.

A motion estimation method performed in the illustrated motion estimation apparatus will be described below.

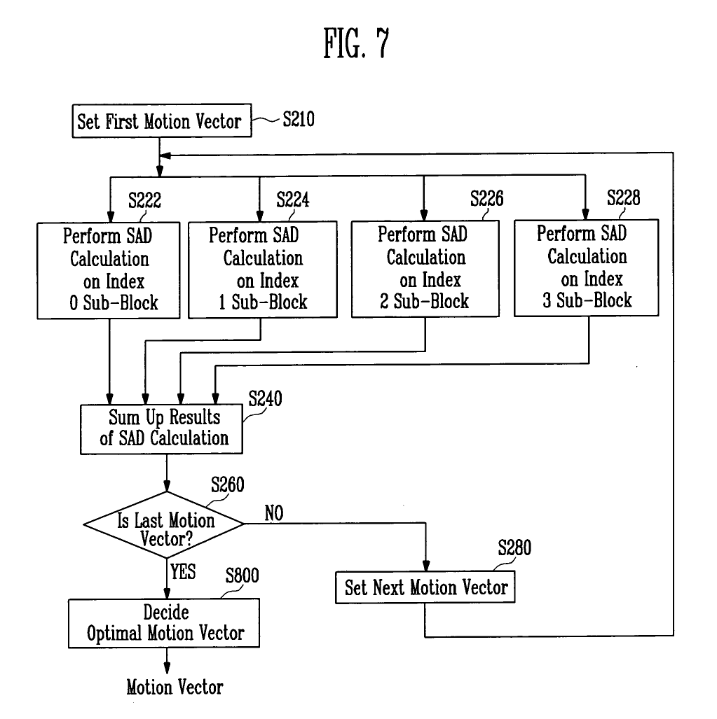

As illustrated in FIG. 6, the motion estimation method includes the steps of: sampling image data in units of predetermined blocks and generating sampling blocks (S100); dividing the sampling blocks into a plurality of sampling sub-blocks (S120); calculating similarities between regions designated by motion vectors with respect to an external specific reference block and the sampling sub-block; and collecting similarities of the motion vectors with respect to the plurality of sampling sub-blocks, and deciding a motion vector with respect to the input image data (S800).

The MPEG-4 and H.264 formats are selectively applied as a compression mode in the illustrated motion estimation method. Therefore, the step of calculating similarities of the illustrated sampling sub-blocks includes the steps of; deciding a compression mode (S140); calculating the similarities in the MPEG-4 format (S200); and calculating the similarities in the H.264 format (S400).

While the drawings show the SAD function being used in the step of calculating similarities of the sampling sub-blocks (S200, S400), the SSD function may be used depending on the application.

Since the motion estimation apparatus receives the 16×16 image data according to an exemplary embodiment of the present invention, the 16×16 image data is sampled into 8×8 image data in the step of generating the sampling blocks (S100). Then, the 8×8 sampling data is divided into four 4×4 sampling sub-blocks in the step of dividing the sampling blocks (S120).

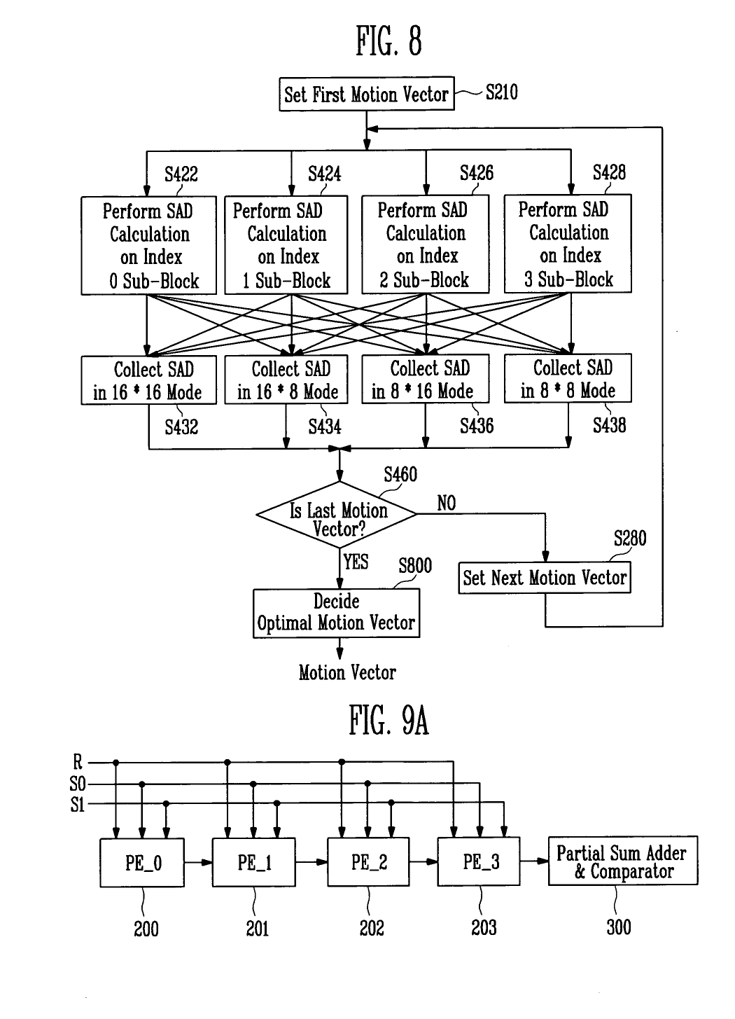

Now, the step of motion calculation (S200) in the MPEG-4 format will be described with reference to FIG. 7.

When four processing elements that respectively perform the SAD calculation on each of the four sampling sub-blocks are provided, the steps of performing the SAD calculation on the sub-blocks (S222, S224, S226 and S228) are simultaneously performed in parallel as illustrated.

While the SAD calculation is performed on the 16×16 image data in the MPEG-4 mode, SAD calculations are respectively performed on four 8×8 blocks of image data in FIG. 7 for parallel processing using the four processing elements. Therefore, addresses of the reference blocks are designated so that SAD calculation with respect to 8×8 image data is substantially equal to SAD calculation with respect to 16×16 image data.

In other words, the motion vectors are designated according to S210 or S280, the address generator calculates addresses of pixels of the reference blocks corresponding to the pixels of the sampling sub-blocks according to the designated motion vector, and each of the processing elements performs SAD calculation using the corresponding pixels.

Therefore, once motion vectors are designated, the SAD calculations with respect to the designated motion vectors are performed four times. And, in the illustrated step of deciding a motion vector (S800), the step of summing up the similarities of the four sampling sub-blocks with respect to one motion vector is performed on all of the motion vectors so that a motion vector having the highest similarity is selected.

The step of motion calculation (S400) in the H.264 compression format will be described in more detail with reference to FIG. 8.

There exist four block grouping modes defined as 16×16, 16×8, 8×16, and 8×8 in H.264 mode, and the SAD calculation with respect to the input image data is performed on all block grouping modes to select the block grouping mode that has the highest processing efficiency.

When four processing elements respectively perform SAD calculations on the four sampling sub-blocks, the steps of performing SAD calculations on the sub-blocks (S422, S424, S426 and S428) are simultaneously performed in parallel as illustrated. Also, the steps (S432, S434, S436 and S438) of collecting SAD values according to the four block grouping modes are simultaneously performed in parallel based on results of the four SAD calculations.

The step of deciding a motion vector in FIG. 6 (S400) may include the steps of calculating similarities in a 16×16 mode; calculating similarities in a 16×8 mode; calculating similarities in an 8×16 mode; and calculating similarities in an 8×8 mode. As illustrated in FIG. 8, the step of calculating similarities in the 16×16 mode includes the steps of performing SAD calculations on the sampling sub-blocks (S422, S424, S426, and S428) and collecting SAD values in the 16×16 mode (S432). Also, the step of calculating similarities in the 16×8 mode includes the steps of performing SAD calculations on the sampling sub-blocks (S422, S424, S426, and S428) and collecting the SAD values in the 16×8 mode (S434). Further, the step of calculating similarities in the 8×16 mode includes the steps of performing SAD calculations on the sampling sub-blocks (S422, S424, S426, and S428), and collecting the SAD values in the 8×16 mode (S436). In addition, the step of calculating similarities in the 8×8 mode includes the steps of performing SAD calculations on the sampling sub-blocks (S422, S424, S426, and S428), and collecting the SAD values in the 8×8 mode (S438).

In the step of calculating similarities in the 16×16 mode, the step of summing up the similarities of the four sampling sub-blocks with respect to one motion vector is performed on all of the motion vectors to select the motion vector that has the highest similarity among the motion vectors, which is almost identical to the process performed in the MPEG-4 format.

In the step of calculating similarities in the 16×8 mode, the four sampling sub-blocks are classified into two groups in the 16×8 mode, a process of summing up similarities of two sampling sub-blocks included in a first group with respect to one motion vector is performed on all of the motion vectors to thereby select the motion vector that has the highest similarity. Also, the step of summing up similarities of two sampling sub-blocks included in a second group with respect to one motion vector is performed on all of the motion vectors to thereby select a motion vector that has the highest similarity, and the step of summing up the similarities of the two selected motion vectors is performed.

In the step of calculating similarities in the 8×16 mode, the four sampling sub-blocks are classified into two groups in the 8×16 mode, the step of summing up similarities of two sampling sub-blocks included in a first group with respect to one motion vector is performed on all of the motion vectors to thereby select a motion vector that has the highest similarity. Also, a process of summing up similarities of two sampling sub-blocks included in a second group with respect to one motion vector is performed on all of the motion vectors to thereby select a motion vector that has the highest similarity, and the step of summing up the similarities of the two selected motion vectors is performed.

In the step of calculating similarities in the 8×8 mode, a process of calculating the similarity of one sampling sub-block with respect to one motion vector is performed on all of the motion vectors to select the motion vector that has the highest similarity. This step is performed on the sampling sub-blocks, and the step of summing up the similarities of the motion vectors selected with respect to each of the sampling sub-blocks is performed.

The step of deciding a motion vector in the H.264 format illustrated in FIG. 6 (S800) corresponds to the steps (S422, S424, S426, and S428) of collecting the SAD calculation results with respect to the four sub-blocks using different methods according to the block grouping mode in the MPEG-4 format.

Since addressing a reference block with respect to a motion vector set to perform SAD calculations on the sampling sub-blocks in FIG. 8 is performed on all of the reference blocks with respect to all of the sampling sub-blocks, setting a motion vector in steps S410 and S480 is performed with a broader scope than in MPEG-4, and there may be a motion vector setting value that is not collected and thus skipped in steps S432, S434, and S436.

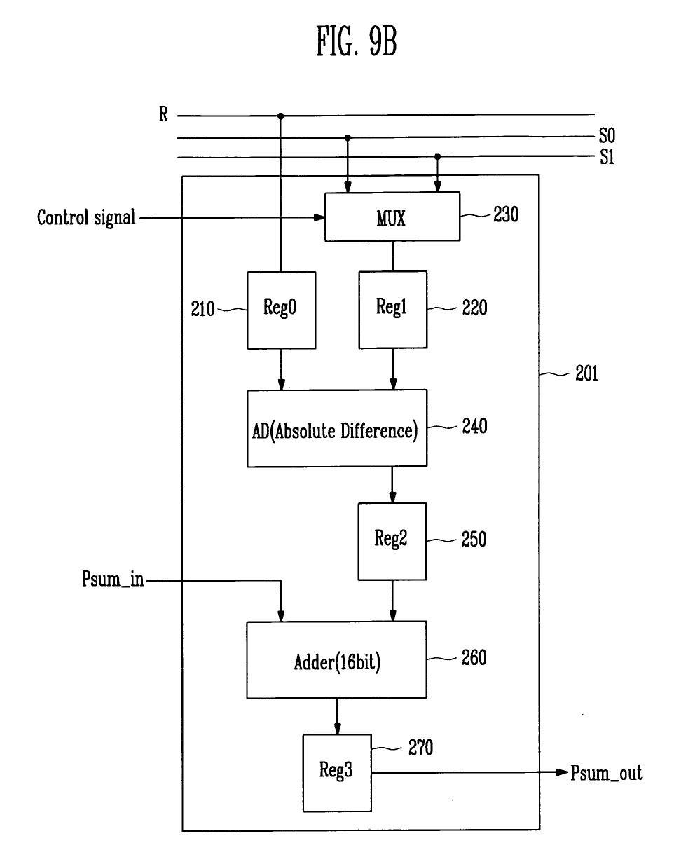

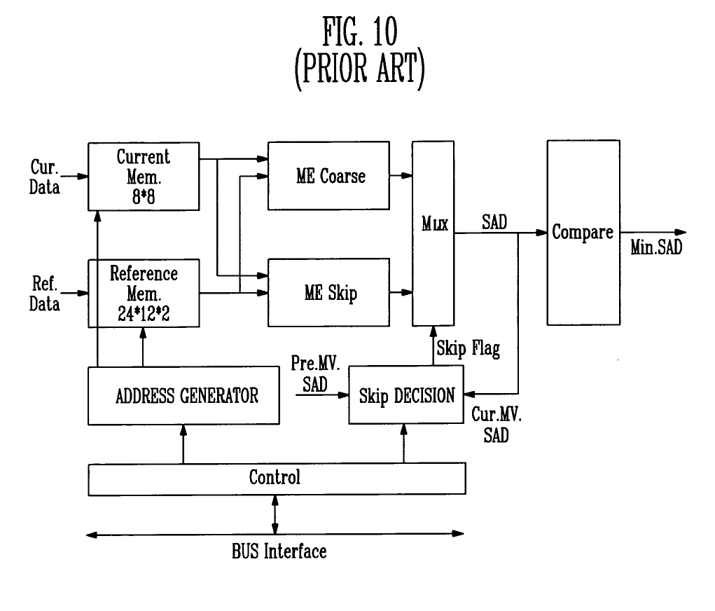

FIGS. 9a and 9b illustrate configurations of processing elements that perform the SAD calculation. The processing structure illustrated in FIG. 9a is directed only to a structure that performs the SAD calculation on one sampling sub-block. However, since the SAD calculation is performed on a 4×4 sampling sub-block that performs a 2:1 sampling process on the original image divided into 8×8 in the present embodiment, the structure includes the four processing elements (200, 201, 202 and 203) and a partial sum adder and a comparator 300.

While the motion calculator 105 of FIG. 1 may include only one processing structure of FIG. 9a, in order to further increase speed it may have four processing structures of FIG. 9a to perform the SAD calculation on all four of the divided sampling sub-blocks simultaneously.

FIG. 9b illustrates a detailed structure of a processing element 201. The illustrated structure compares two previous frames adjacent to the current frame for SAD calculation, and simultaneously performs the SAD calculation on both of the two previous frames to enhance calculation speed.

More specifically, R denotes an input of the current data and S0 and S1 denote inputs of the previous frame data, which are input as a sequence of odd and even frames. The present invention has a structure that internally processes the input using two inputs of the processing elements twice as fast data that is alternately input as a sequence of odd and even frames, and has 100% processing efficiency except during a time period for setting an initial value.

Also, SAD values are obtained using the four processing elements. Psum_in is a value for storing a preliminary SAD value and stores a median SAD value of PE_0, PE_1, and PE_3 and is summed with a current value to perform the SAD calculation.

As described above, a motion estimation apparatus and method according to the exemplary embodiments of the present invention can reduce time consumed for calculation since it performs a Sum of Absolute Difference (SAD) calculation on four sampling sub-blocks simultaneously, and selects an optimal condition according to a mode. Also, the amount of calculation and used memory are reduced by a reduction of the input image data to one-quarter using a sampling scheme of 2:1.

A motion estimation apparatus and method according to the present invention have an effect of reducing hardware cost and an amount of calculation.

That is, an SAD calculation is performed on each of the sub-blocks using only four processing elements due to block division. Thus, algorithms and a structure for calculating a motion vector are provided which can reduce hardware cost to one-quarter of in the conventional method.

Further, since the calculation is performed in each mode using the four processing elements in the present invention, motion estimation in H.264 can be implemented with lower hardware cost than before and may be used as core technology in a low-power portable multimedia terminal, etc.

Also, since the SAD calculation is simultaneously performed on the divided sampling sub-blocks, less time is consumed for the calculation.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A motion estimation apparatus, comprising:
a sampling portion for sampling image data in units of blocks and generating sampling blocks;
a block division/address generator for dividing the sampling blocks into sampling sub-blocks and generating addresses for motion estimation calculation; and
a motion calculator for calculating motion using a motion estimation function for each sub-block.

2. The apparatus according to claim 1, further comprising a sampling memory for storing the data sampled by the sampling portion.

3. The apparatus according to claim 1, further comprising an optimal mode decision portion for deciding an optimal block grouping mode for moving picture compression.

4. The apparatus according to claim 1, wherein the sampling portion performs sampling of 16×16 image data into 8×8 sampling blocks, and the block division/address generator divides each of the 8×8 sampling blocks into four 4×4 sampling sub-blocks.

5. The apparatus according to claim 1, wherein the motion estimation function is one of a Sum of Absolute Differences (SAD), a Sum of Absolute Hadamard Transformed Differences (SATD), and a Sum of Square Differences (SSD).

6. The apparatus according to claim 1, wherein the motion calculator comprises four processing structures for calculating similarities between data of each sampling sub-block and reference image data for motion estimation.

7. The apparatus according to claim 1, wherein the motion calculator sums up the similarities of four sampling sub-blocks with respect to one motion vector, and selects a motion vector that has the highest similarity.

8. The apparatus according to claim 1, wherein the motion calculator performs:
calculating similarities in a 16×16 mode;
calculating similarities in a 16×8 mode;
calculating similarities in an 8×16 mode;
calculating similarities in an 8×8 mode; and
deciding an optimal mode according to results of calculating similarities in the four modes.

9. The apparatus according to claim 1;
wherein the motion calculator determines whether the mode is an MPEG-4 mode or an H.264 mode, when the motion calculator determines that the mode is the MPEG-4 mode, it performs the step of summing up similarities of the four sampling sub-blocks with respect to each and every motion vector to select a motion vector that has the highest similarity, and when the motion calculator determines that the mode is the H.264 mode, it performs:
calculating similarities in a 16×16 mode;
calculating similarities in a 16×8 mode;
calculating similarities in an 8×16 mode;
calculating similarities in an 8×8 mode; and
deciding an optimal mode according to the results of calculating similarities in the four modes.

10. A motion estimation method, comprising the steps of:
sampling image data in units of predetermined blocks to thereby generate sampling blocks;
dividing each of the sampling blocks into a plurality of sampling sub-blocks;
calculating similarities between a region designated by each motion vector with respect to an external specific reference block and each of the sampling sub-blocks; and
summing up the similarities of the motion vectors with respect to the plurality of sampling sub-blocks to thereby decide a motion vector with respect to the input image data.

11. The method according to claim 10, wherein the step of generating the sampling blocks comprises the step of sampling 16×16 image data into 8×8 image data, and the step of dividing the sampling blocks comprises the step of dividing the 8×8 sampling data into four 4×4 sampling sub-blocks.

12. The method according to claim 10, wherein in the step of calculating similarities of the sampling sub-blocks, a Sum of Absolute Differences (SAD) function or a Sum of Square Difference (SSD) function is used.

13. The method according to claim 11, wherein the step of deciding the motion vector comprises the step of summing up the similarities of the four sampling sub-blocks with respect to each and every motion vector to thereby select a motion vector that has the highest similarity.

14. The method according to claim 11, wherein the step of deciding the motion vector comprises the steps of:
calculating similarities in a 16×16 mode;
calculating similarities in a 16×8 mode;
calculating similarities in an 8×16 mode;
calculating similarities in an 8×8 mode; and
deciding an optimal mode according to results of the steps of calculating similarities in the four modes.

15. The method according to claim 11, wherein the step of deciding the motion vector comprises the step of determining whether the mode is an MPEG-4 mode or an H.264 mode, when the mode is the MPEG-4 mode, summing up similarities of the four sampling sub-blocks with respect to each and every motion vector to select a motion vector that has the highest similarity, and when the mode is the H264 mode, performing the steps of:
calculating similarities in a 16×16 mode;
calculating similarities in a 16×8 mode;
calculating similarities in an 8×16 mode;
calculating similarities in an 8×8 mode; and
deciding an optimal mode according to the results of the steps of calculating similarities in the four modes.

16. The method according to claim 14, wherein the step of calculating similarities in the 16×16 mode comprises the steps of: summing up similarities of the four sampling sub-blocks with respect to each and every motion vector; and selecting a motion vector that has the highest similarity,
wherein the step of calculating similarities in the 16×8 mode comprises the steps of: grouping the four sampling sub-blocks into two groups for the 16×8 mode; summing up the similarities of two sampling sub-blocks of a first group with respect to each and every motion vector to select a motion vector that has the highest similarity; summing up the similarities of two sampling sub-blocks of a second group with respect to each and every motion vector to select a motion vector that has the highest similarity; and summing up the similarities of the two selected motion vectors,
wherein the step of calculating similarities in the 8×16 mode comprises the steps of: grouping the four sampling sub-blocks into two groups for the 8×16 mode; summing up the similarities of two sampling sub-blocks of a first group with respect to each and every motion vector to select a motion vector that has the highest similarity; summing up the similarities of two sampling sub-blocks of a second group with respect to each and every motion vector to select a motion vector that has the highest similarity; and summing up the similarities of the two selected motion vectors, and
wherein the step of calculating similarities in the 8×8 mode comprises the steps of: calculating a similarity of each sampling sub-block with respect to each and every motion vector to thereby select a motion vector that has the highest similarity; and summing up the similarities of the motion vectors selected with respect to the sampling sub-blocks.

17. The method according to claim 15, wherein the step of calculating similarities in the 16×16 mode comprises the steps of: summing up similarities of the four sampling sub-blocks with respect to each and every motion vector; and selecting a motion vector that has the highest similarity,
wherein the step of calculating similarities in the 16×8 mode comprises the steps of: grouping the four sampling sub-blocks into two groups for the 16×8 mode; summing up the similarities of two sampling sub-blocks of a first group with respect to each and every motion vector to select a motion vector that has the highest similarity; summing up the similarities of two sampling sub-blocks of a second group with respect to each and every motion vector to select a motion vector that has the highest similarity; and summing up the similarities of the two selected motion vectors,
wherein the step of calculating similarities in the 8×16 mode comprises the steps of: grouping the four sampling sub-blocks into two groups for the 8×16 mode; summing up the similarities of two sampling sub-blocks of a first group with respect to each and every motion vector to select a motion vector that has the highest similarity; summing up the similarities of two sampling sub-blocks of a second group with respect to each and every motion vector to select a motion vector that has the highest similarity; and summing up the similarities of the two selected motion vectors, and
wherein the step of calculating similarities in the 8×8 mode comprises the steps of: calculating a similarity of each sampling sub-block with respect to each and every motion vector to thereby select a motion vector that has the highest similarity; and summing up the similarities of the motion vectors selected with respect to the sampling sub-blocks.
